(19) United States
(12) Patent Application Publication
(10) Pub. No.: US 2025/0045672 A1
(43) Pub. Date: Feb. 6, 2025

(54) METHODS FOR VISUALIZING RELOCATION ANALYTICS AND SYSTEMS THEREOF

(71) Applicant: Jones Lang LaSalle IP, Inc., Chicago, IL (US)

(72) Inventors: Jiarong LI, Shanghai City (CN); Kuang SHENG, Shanghai City (CN); Larry YANG, Shanghai City (CN); Spencer ZHOU, Shanghai City (CN); Susan ZHANG, Shanghai City (CN); Wenjie YANG, Shanghai City (CN)

(21) Appl. No.: 18/228,027

(22) Filed: Jul. 31, 2023

(51) Int. Cl. G06Q 10/0637; G06Q 10/067

(52) U.S. Cl. CPC G06Q 10/06375; G06Q 10/067

(57) ABSTRACT

Methods, non-transitory computer readable media, and relocation analysis systems are disclosed that obtain employee data, a current office address, and relocation data. A first commute time is determined using a maps platform API to the current office address and a second commute time is determined to each of the relocation offices. A dashboard GUI is output for display that includes a commute time ranking of the relocation offices and a heat map reflecting a density of employee locations determined based on home addresses and including selectable locations of the relocation offices. A first commute time distribution is generated based on the first commute times and a second commute time distribution is generated based on the second commute times for one of the relocation offices corresponding to a selected one of the selectable locations. The dashboard GUI is then updated to include a visualization generated based on the commute time distributions.

### FIELD

This technology generally relates to improved graphical user interfaces (GUIs) for analytics data and, more particularly, to arranging generated relocation analytics on a GUI with improved visualizations.

### BACKGROUND

Enterprises are increasingly engaging in change management plans that involve the relocation, dispersing, and/or condensing of office space as work patterns, residential location preferences, and remote work policies evolve. Change management plans have varying goals from increasing on-site or in-person collaboration among employees, reducing the enterprise's carbon footprint, and reducing real estate costs to improving employee morale. Conversely, commercial real estate brokers that market commercial properties for lease do not have any quantitative data or electronic graphical reports regarding the employees of a corporate client, for example, which could inform a prospective tenant's decision to lease office space.

Current digital techniques used to inform relocation decisions are restricted to employee polling to determine office location preferences for employees, which is inefficient and has limited accuracy based on survey response. Polling uses significant computing resources and employee time and is susceptible to being ignored, resulting in decisions for the many made based on responses by the few. The preference data obtained from polling also lacks any detailed or granular analysis or associated visualizations and is difficult to interpret. Reliance on such preference data can result in an enterprise failing to achieve goal(s) of a change management plan or an environmental, social, and governance (ESG) plan, particularly with respect to employee happiness and an enterprise's carbon footprint.

Thus, current computing systems that provide reports to inform relocation decisions are limited to tallying and graphically presenting votes relating to prospective relocation offices received via polls. These current computing systems have limited knowledge regarding available commercial leases, do not interface with external systems or leverage any employee data or quantitative analysis to support the resulting reports, do not facilitate interactivity, and are inefficient and facilitate ineffective graphical interfaces and reports that fail to effectively inform commercial office relocation decisions for enterprises.

### SUMMARY

In one example, a method for visualizing relocation analytics is disclosed that is implemented by a relocation analysis system and includes obtaining employee data comprising home addresses for employee residences for employees, a current office address for a current office, and relocation data comprising prospective office addresses for relocation offices. Using a maps platform application programming interface (API), a first commute time is determined for each of the employees to the current office and a second commute time is determined for each of the employees to each of the relocation offices. The first commute times are determined based on the home addresses and the current office address and the second commute times are determined based on the home addresses and the prospective office addresses. A dashboard graphical user interface (GUI) is then generated, and output to an enterprise user device for display, that includes a commute time ranking of the relocation offices and a heat map including selectable locations of the relocation offices and a graphical representation of an employee density determined based on the home addresses. The commute time ranking is generated based on the second commute time for each of the relocation offices. A first commute time distribution is then generated based on the first commute times and a second commute time distribution is generated based on the second commute times for one of the relocation offices in response to a selection of one of the selectable locations corresponding to the one of the relocation offices received from the enterprise user device via the dashboard GUI. The dashboard GUI is updated to include a visualization generated based on the first and second commute time distributions and output to the enterprise user device for display.

In another example, a relocation analysis system is disclosed that includes memory including instructions stored thereon and one or more processors configured to execute the stored instructions to obtain employee data comprising home addresses for employee residences for employees, a current office address for a current office, and relocation data comprising prospective office addresses for relocation offices. Using a maps platform API, a first commute time is determined for each of the employees to the current office and a second commute time is determined for each of the employees to each of the relocation offices. The first commute times are determined based on the home addresses and the current office address and the second commute times are determined based on the home addresses and the prospective office addresses. A dashboard GUI is then generated, and output to an enterprise user device for display, that includes a commute time ranking of the relocation offices and a heat map including selectable locations of the relocation offices and a graphical representation of an employee density determined based on the home addresses. The commute time ranking is generated based on the second commute time for each of the relocation offices. A first commute time distribution is then generated based on the first commute times and a second commute time distribution is generated based on the second commute times for one of the relocation offices in response to a selection of one of the selectable locations corresponding to the one of the relocation offices received from the enterprise user device via the dashboard GUI. The dashboard GUI is updated to include a visualization generated based on the first and second commute time distributions and output to the enterprise user device for display.

In yet another example, a non-transitory computer readable media is disclosed that has instructions for visualizing relocation analytics stored thereon and includes executable code that, when executed by one or more processors, causes the processors to obtain employee data comprising home addresses for employee residences for employees, a current office address for a current office, and relocation data comprising prospective office addresses for relocation offices. Using a maps platform API, a first commute time is determined for each of the employees to the current office and a second commute time is determined for each of the employees to each of the relocation offices. The first commute times are determined based on the home addresses and the current office address and the second commute times are determined based on the home addresses and the prospective office addresses. A dashboard GUI is then generated, and output to an enterprise user device for display, that includes a commute time ranking of the relocation offices and a heat map including selectable locations of the relocation offices and a graphical representation of an employee density determined based on the home addresses. The commute time ranking is generated based on the second commute time for each of the relocation offices. A first commute time distribution is then generated based on the first commute times and a second commute time distribution is generated based on the second commute times for one of the relocation offices in response to a selection of one of the selectable locations corresponding to the one of the relocation offices received from the enterprise user device via the dashboard GUI. The dashboard GUI is updated to include a visualization generated based on the first and second commute time distributions and output to the enterprise user device for display.

This technology provides a number of advantages including methods, non-transitory computer readable media, and relocation analysis systems that interface with maps platform server APIs to generate peak or rush hour commute time and emissions data based on obtained employee locations and prospective and current office locations. Thus, the relocation analysis systems of this technology process a large amount of data for enterprises and present the resulting analytics via improved GUIs with particular arrangements of interactive graphs, charts, rankings, heat maps, and other visualizations to inform relocation decisions.

### BRIEF DESCRIPTION OF THE DRAWINGS

FIG. 1 is a block diagram of an exemplary network environment with a relocation analysis system;

FIG. 2 is a block diagram of an exemplary relocation analysis system;

FIG. 3 is a flowchart of an exemplary method for visualizing relocation analytics;

FIG. 4 is a screenshot of an exemplary data ingestion interface;

FIG. 5 is a screenshot of an exemplary dashboard graphical user interface (GUI) with a heatmap of employee density;

FIG. 6 is a screenshot of an exemplary dashboard GUI with commute time and emissions rankings; and

FIG. 7 is a screenshot of an exemplary dashboard GUI with comparison visualizations.

### DETAILED DESCRIPTION

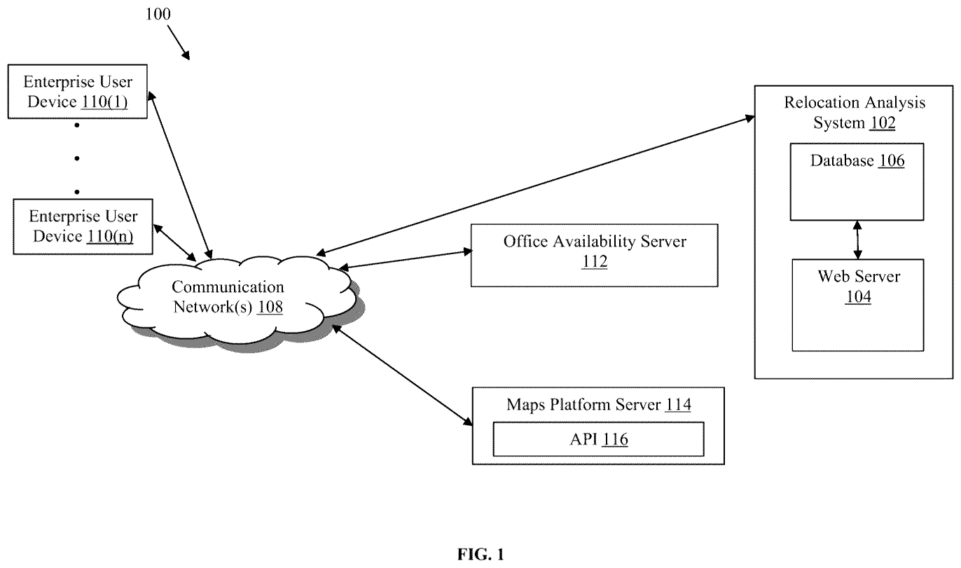

Referring to FIG. 1, an exemplary network environment 100 is illustrated that includes a relocation analysis system 102, with a web server 104 coupled to a backend database 106, which is coupled via communication network(s) 108 to enterprise user devices 110(1)-110(n), office availability server 112, and maps platform server 114 hosting API 116. The network environment 100 may include other network devices such as one or more routers or switches, for example, which are known in the art and thus will not be described herein. This technology has a number of advantages including methods, non-transitory computer readable media, and relocation analysis systems that provide improved interactive graphical user interfaces (GUIs) for relocation analytics data that is generated more efficiently using fewer computing resources than polling or surveying technology.

In this example, the enterprise user devices 110(1)-110(n), office availability server 112, maps platform server 114, web server 104, and database 106 are disclosed in FIG. 1 as dedicated hardware devices. However, one or more of enterprise user devices 110(1)-110(n), office availability server 112, maps platform server 114, web server 104, or database 106 can also be implemented in software within one or more other devices in the network environment. As one example, the database 106, as well as any of its components or applications, can be implemented as software executing on the web server 104, and many other permutations and types of implementations and network topologies can also be used in other examples.

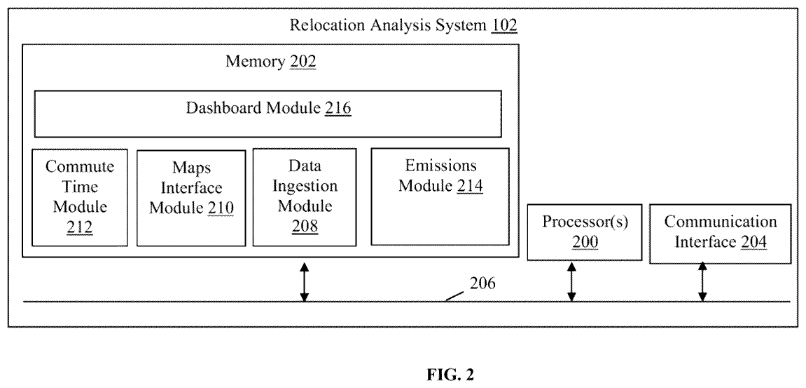

Referring to FIGS. 1-2, the relocation analysis system 102 may perform any number of functions, including providing GUIs to the enterprise user devices 110(1)-110(n) and to facilitate presentation of and interaction with relocation analytics data regarding, and perform other functions as described and illustrated in detail below. The relocation analysis system 102 (e.g., the web server 104 of the relocation analysis system 102) in this example includes processor(s) 200, memory 202, and a communication interface 204, which are coupled together by a bus 206, although the relocation analysis system 102 can include other types or numbers of elements in other configurations.

The processor(s) 200 of the relocation analysis system 102 may execute programmed instructions stored in the memory 202 of the relocation analysis system 102 for any number of the functions described and illustrated herein. The processor(s) 200 may include one or more processing cores, one or more central processing units, and/or one or more graphics processing units, for example, although other types of processor(s) can also be used.

The memory 202 stores these programmed instructions for one or more aspects of the present technology as described and illustrated herein, although some or all of the programmed instructions could be stored elsewhere. A variety of different types of memory storage devices, such as random-access memory (RAM), read only memory (ROM), hard disk, solid state drives, flash memory, or other computer readable medium which is read from and written to by a magnetic, optical, or other reading and writing system that is coupled to the processor(s) 200, can be used for the memory 202.

Accordingly, the memory 202 can store applications that can include computer executable instructions that, when executed by the processor(s) 200, cause the relocation analysis system 102 to perform actions, such as to transmit, receive, or otherwise process network messages and requests and generate graphical interfaces and displays, for example, and to perform other actions described and illustrated below. The application(s) can be implemented as components of other applications, operating system extensions, and/or plugins, for example.

Further, the application(s) may be operative in a cloud-based computing environment with access provided via a software-as-a-service (Saas) model. The application(s) can be executed within or as virtual machine(s) or virtual server(s) that may be managed in a cloud-based computing environment. Also, the application(s), and even the relocation analysis system 102 itself, may be located in virtual server(s) running in a cloud-based computing environment rather than being tied to specific physical network computing devices.

In some examples, the memory 202 includes a data ingestion module 208, a maps interface module 210, a commute time module 212, an emissions module 214, and a dashboard module 216, although other modules can also be used in other examples. The data ingestion module 208 is configured to interface with the enterprise user devices 110(1)-110(n) via the communication network(s) 108 to obtain a current office address for an enterprise and employee data for employees of the enterprise, including employee home or residence addresses. The data ingestion module 208 is configured to sanitize or anonymize the employee data to remove any personally identifiable information.

Additionally, the data ingestion module 208 in some examples is configured to interface with the office availability server 112 (e.g., via an API) to obtain relocation data including prospective office addresses for relocation offices or other commercial real estate available for lease that meets certain parameters (e.g., can accommodate number of employees, available within a defined timeframe, and/or located within a defined radius from a current office location). In other examples, the relocation data can be obtained from the enterprise user devices 110(1)-110(n), as explained in more detail below. Optionally, the current office address, employee data, and/or relocation data can be maintained in the database 106 of the relocation analysis system 102, which can be a relational database (e.g., a Structured Query Language (SQL) database), although other types of databases can also be used in other examples.

The maps interface module 210 is configured to interface with the API 116 of the maps platform server 114 to determine commute times to a current office and relocation offices for employees. The maps interface module 210 can make a call to the API 116 using parameters such as the time of day (e.g., rush hour) and the employee and office addresses, for example. The maps interface module 210 can also obtain the modes of transportation (e.g., public transit, personal vehicle, walking, etc.) that are required by the journey(s) or commutes of each of the employees. In some examples, the maps interface module 210 can interface with the Routes API hosted by the Google Maps Platform offered by Google LLC of Mountain View, California, although other APIs can also be used in other examples.

The commute time module 212 can be configured to aggregate and analyze the data obtained by the maps interface module 210 to generate commute time distributions for employees and rankings for relocation offices, for example. Similarly, the emissions module 214 can be configured to aggregate and analyze the data obtained by the maps interface module 210 to generate emissions distributions for employees and rankings for relocation offices, for example. The emissions module 214 can apply stored emissions values to the modes of transportation and distance information in the data obtained by the maps interface module to generate the emissions distributions.

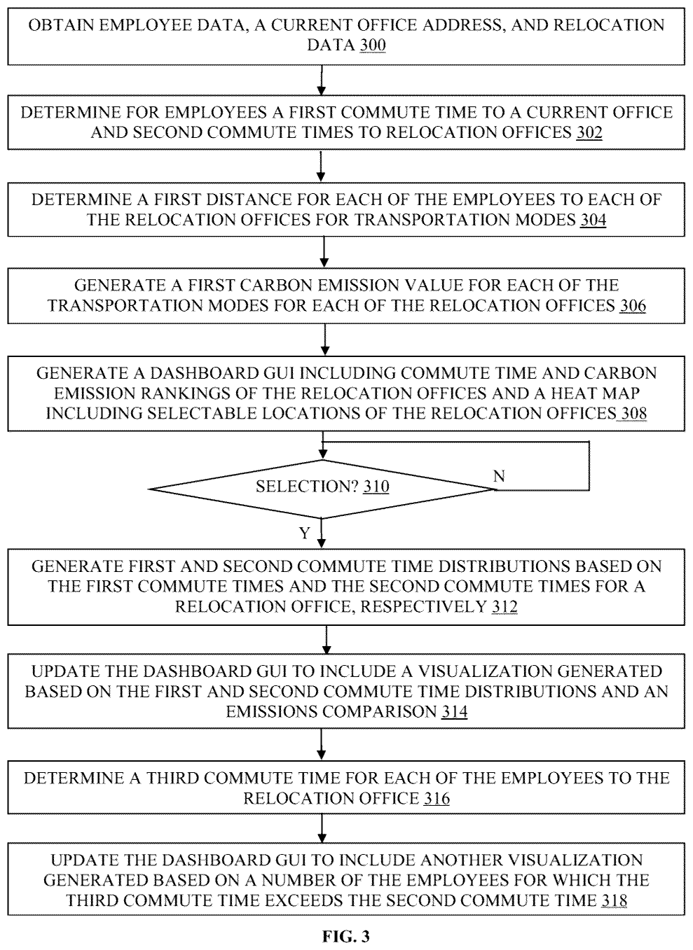

The dashboard module 216 then leverages the distributions and rankings generated by the commute time module 212 and emissions module 214 to generate interactive GUIs with heat maps and other visualizations to inform office relocation decisions. The operation of the dashboard module 216 will be described and illustrated in more detail below with reference to FIGS. 3-7.

The communication interface 204 of the relocation analysis system 102 operatively couples and communicates between the relocation analysis system 102, enterprise user devices 110(1)-110(n), office availability server 112, and maps platform server 114, which are coupled together at least in part by the communication network(s) 108 in this particular example, although other types or numbers of communication networks or systems with other types or numbers of connections or configurations to other devices or elements can also be used. The communication network(s) 108 can include wide area network(s) (WAN(s)) and/or local area network(s) (LAN(s)), for example, and can use TCP/IP over Ethernet and industry-standard protocols, although other types or numbers of protocols or communication networks can be used. The communication network(s) 108 can employ any suitable interface mechanisms and network communication technologies including, for example, Ethernet-based Packet Data Networks (PDNs).

The relocation analysis system 102 in some examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory 202, communication interface 204, or other hardware or software components of one or more other devices included in the relocation analysis system 102. Additionally, one or more of the devices that together comprise the relocation analysis system 102 in other examples can be standalone devices or integrated with one or more other devices or apparatuses.

The office availability server 112 can include processor(s), memory, and a communication interface, which are coupled together by a bus or other communication link (not illustrated), although other numbers or types of components could also be used. The office availability server 112 can host or interface with listing services and/or commercial real estate databases that include data regarding available offices, such as cost, size, availability timing, and/or address, for example. Accordingly, the service provider servers 114(1)-114(c) can provide API endpoints, for example, that intake prospective relocation office requests with particular criteria from the relocation analysis system 102 and return data regarding available commercial real estate, including at least the address of available relocation offices.

The maps platform server 114 also can include processor(s), memory, and a communication interface, which are coupled together by a bus or other communication link (not illustrated), although other numbers or types of components could also be used. The maps platform server 114 can host databases and modules configured to determine commute information including distances, times, and modes of transportation for employees to current and relocation offices. Accordingly, the maps platform server 114 can provide the API 116 that intakes commute requests with criteria from the relocation analysis system 102 and returns commute data regarding available commercial real estate, including at least the address of available relocation offices.

Each of the enterprise user devices 110(1)-110(n) of the network environment 100 in this example includes any type of computing device that can exchange network data, such as mobile, desktop, laptop, or tablet computing devices. Each of the enterprise user devices 110(1)-110(n) includes processor(s), memory, and a communication interface, which are coupled together by a bus or other communication link (not illustrated), although other numbers or types of components could also be used.

Each of the enterprise user devices 110(1)-110(n) may run interface applications, such as web browsers or standalone applications, which may provide an interface to communicate with the relocation analysis system 102 via the communication network(s) 108. Each of the enterprise user devices 110(1)-110(n) may further include a display device, such as a display screen or touchscreen, or an input device, such as a keyboard or mouse, for example (not shown). One or more of the enterprise user devices 110(1)-110(n) may be associated with an individual user (e.g., a change management plan administrator for an enterprise), for example.

Although the exemplary network environment 100 with the enterprise user devices 110(1)-110(n), office availability server 112, maps platform server 114, relocation analysis system 102, and communication network(s) 108 is described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the enterprise user devices 110(1)-110(n), office availability server 112, maps platform server 114, or relocation analysis system 102, for example, may be configured to operate as virtual instances on the same physical machine. In other words, one or more of the enterprise user devices 110(1)-110(n), office availability server 112, maps platform server 114, or relocation analysis system 102 may operate on the same physical device rather than as separate devices communicating through the communication network(s) 108. Additionally, there may be more or fewer enterprise user device, office availability servers, maps platform servers, or relocation analysis systems than illustrated in FIG. 1.

The examples of this technology may also be embodied as one or more non-transitory computer readable media having instructions stored thereon, such as in the memory 202 of the relocation analysis system 102, for one or more aspects of the present technology, as described and illustrated by way of the examples herein. The instructions in some examples include executable code that, when executed by one or more processors, such as the processor(s) 200 of the relocation analysis system 102, cause the processors to carry out steps necessary to implement the methods of the examples of this technology that will now be described and illustrated herein.

Referring now to FIG. 3, a flowchart of an exemplary method for visualizing relocation analytics is illustrated. In step 300 in this example, the relocation analysis system 102 obtains and optionally stores employee data, a current office address for a current office, and relocation data. The employee data includes home addresses for employee residences for employees of a particular enterprise located at the current office address. The term employees as used herein includes any set of people having an association with a particular address (i.e., the current office address in this example). The term office as used herein includes any commercial real estate property (e.g., warehouse, facility, medical center, etc.) to which employees commute. The relocation data in this example includes prospective office addresses for relocation offices to which the employees associated with the employee data would commute following a relocation of the current office.

In this example, the member data is ingested from the enterprise user devices 110(1)-110(n) (e.g., using forms provided by the relocation analysis system 102 or via provided electronic files that are automatically parsed and processed). In some examples, the relocation data can also be ingested from the enterprise user devices 110(1)-110(n) and, in other examples, the relocation data 212 can be ingested via the office availability server 112, for example. In these examples, the relocation analysis system 102 can generate a list of available offices satisfying parameters using an API provided by the office availability server 112. The list of available offices can then be provided to one of the enterprise user devices 110(1)-110(n) for selection by a user, for example. Other methods of obtaining the employee data, current office address, and/or relocation data can also be used.

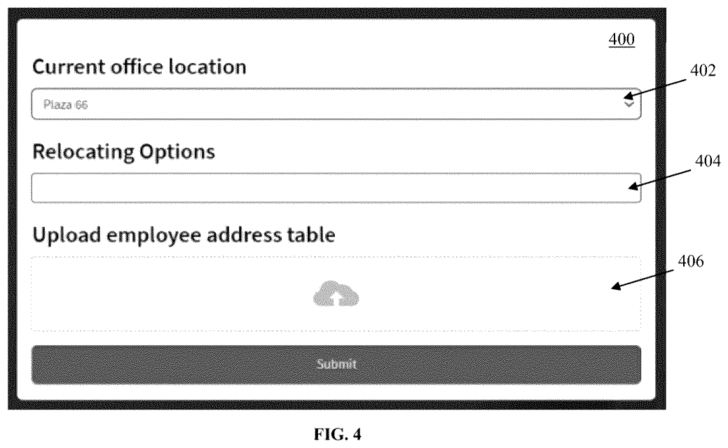

Referring to FIG. 4, a screenshot of an exemplary data ingestion interface 400 is illustrated. The data ingestion interface 400 can be generated by the relocation analysis system 102 and provided to one of the enterprise user devices 110(1)-110(n) upon request. In this example, the data ingestion interface 400 includes a first input field 402 for a current office location (e.g., a current office address), a second input field 404 for relocating options (e.g., prospective office addresses), and a third input field 406 configured to facilitate uploading of employee data.

Optionally, the second input field can be populated based on the list of available offices obtained from the office availability server 112 such that a user can select the relocation offices to include the current analysis. Also optionally, multiple first input fields can be provided for multiple current office addresses and the employee data can include an association of home addresses to the office associated with each of the current office addresses. In these examples, the enterprise may be considering a consolidation from multiple current offices. In other examples, the enterprise can use the technology described and illustrated herein to analyze and inform a dispersion from a single (or more) current office to multiple relocation offices.

Referring back to FIG. 3, in step 302, the relocation analysis system 102 determines a first commute time for each of the employees to the current office and a second commute time for each of the employees to each of the relocation offices. The determinations in step 302 are based on the data ingested in step 300. Specifically, the first commute times are determined based on the home addresses and the current office address and the second commute times are determined based on the home addresses and the prospective office addresses. In some examples, the home addresses and the current office address (for the first commute times) and the prospective office addresses (for the second commute times) are provided to the maps platform server 114 via a call to the API 116, which is configured to use stored, historical data to generate the first and second commute times for each of the employee, optionally during a peak or rush hour time period. Other methods for generating the first and second commute times can also be used in other examples.

In step 304, the relocation analysis system 102 determines a first distance for each of the employees to each of the relocation offices for each of a plurality of transportation modes (e.g., public transit, personal vehicle, or walking). In this example, the first distances are determined based on the home addresses and the prospective office addresses using the API 116 provided by the maps platform server 114.

In step 306, the relocation analysis system 102 generates a first carbon emission value for each of the transportation modes for each of the relocation offices for each of the employees based on a stored emission value for each of the transportation modes and the first distances corresponding to each of the transportation modes. For example, the relocation analysis system 102 may determine that to commute to one of the relocation offices, one of the employees would have to walk one mile for 15 minutes to get to public transit, ride the public transit for three miles and 20 minutes, and then walk another mile for 15 minutes to the relocation office. The relocation analysis system 102 can then apply a default, stored public transit emissions per mile value to the three miles of public transit to generate a carbon emissions value for the employee for the public transit transportation mode. Other permutations of transportation modes, other types of transportation modes, and other types of stored or obtained emissions values can also be used in other examples.

In step 308, the relocation analysis system 102 generates, and outputs to a requesting one of the enterprise user devices 110(1)-110(n) for display, a dashboard GUI 500 that includes one or more visualizations of the analytics data obtained and processed as described above. For example, the relocation analysis system can generate the dashboard GUI to include a commute time ranking of the relocation offices. The commute time ranking can be generated based on the second commute times for each of the relocation offices determined in step 302. For example, the second commute times for each of the employees to each respective one of the relocation offices can be aggregated or averaged to generate a relocation commute time value for each of the relocation offices. The relocation commute times value can then be used to rank the relocation offices on the dashboard GUI according to commute time associated with employee commutes to those relocation offices.

In another example, the relocation analysis system 102 can generate the dashboard GUI 500 to include a carbon emission ranking of the relocation offices. The carbon emission ranking can be generated based on the first carbon emission values determined in step 302. For example, the first carbon emission values for each of the transportation modes for each of the relocation offices can be aggregated or averaged to generate a relocation emission value for each of the transportation modes for each of the relocation offices. The relocation emission values can then be used to rank the relocation offices on the dashboard GUI according to carbon emissions associated with employee commutes to those relocation offices.

In yet another examples, the relocation analysis system 102 can generate the dashboard GUI 500 to include a heat map including selectable locations of the relocation offices and a graphical representation of an employee density. The employee density can be determined based on the home addresses obtained in step 300 and the heat map advantageously provides a visualization of employee residence location as compared to the relocation offices and, optionally, the current office.

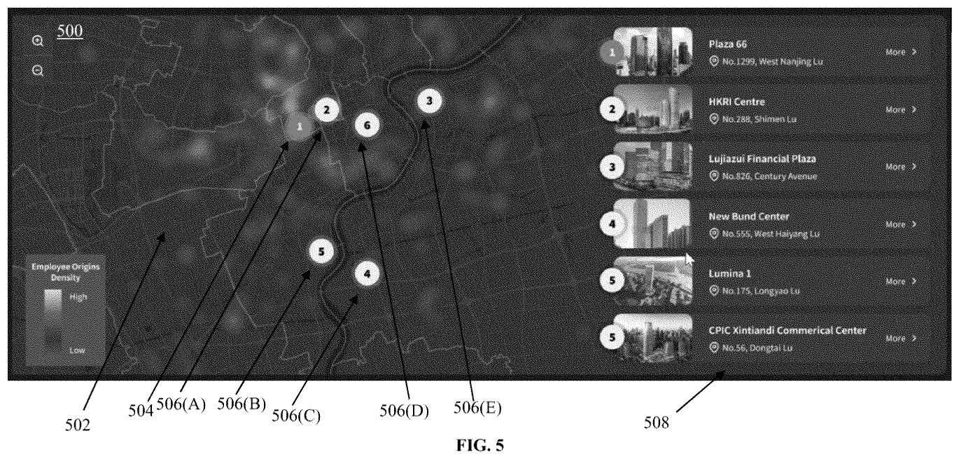

Referring to FIG. 5, a screenshot of an exemplary dashboard GUI 500 with a heatmap 502 of employee density is illustrated. In this example, the heat map includes color to represent employee density. The heat map includes a geographic map as a backdrop and a current office indication 504 placed at the location of the current office address. Additionally, the heat map 502 includes selectable locations 506(A)-(E) placed at locations on the geographic map corresponding to the prospective office addresses of the relocation offices. In this example, the dashboard GUI 500 also includes a selectable list 508 of the relocation offices that facilitates a highlighting or other salience on the heat map 502 with respect to a relocation office selection.

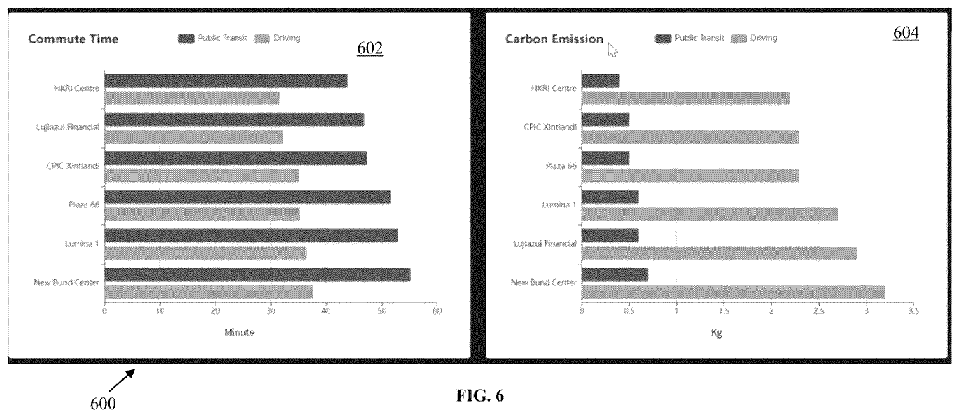

Referring to FIG. 6, a screenshot of another dashboard GUI 600 with a commute time ranking 602 and an emission ranking 604 is illustrated. The commute time ranking in this example includes commute time data for each of the relocation offices along with the current office graphically presented according to transportation mode (i.e., public transit and driving). Similarly, the emission ranking 604 includes emission data for each of the relocation offices and the current office graphically presented according to the same transportation modes. Other types of visualizations can also be included in other examples.

Referring back to FIG. 3, in step 310, the relocation analysis system 102 determines whether a selection is received (e.g., from one of the enterprise user devices 110(1)-110(n)) of one of the selectable locations of the relocation offices displayed via the dashboard GUI. If the relocation analysis system 102 determines that a selection has not been received, then the No branch is taken back to step 310 and the relocation analysis system 102 effectively waits for a selection. However, if the relocation analysis system 102 determines that a selection of one of the selectable locations of the relocation offices has been received, then the Yes branch is taken to step 312.

In step 312, the relocation analysis system 102 generates a first commute time distribution based on the first commute times determined in step 302 and a second commute time distribution based on the second commute times determined in step 302 for one of the relocation offices in response to the selection of one of the selectable locations corresponding to the one of the relocation offices received from one of the enterprise user devices 110(1)-110(n) via the dashboard GUI.

In step 314, the relocation analysis system 102 updating the dashboard GUI or generates a new dashboard GUI to include a visualization generated based on the first and second commute time distributions and outputs the updated dashboard GUI to the one of the enterprise user devices 110(1)-110(n) for display. In one example, the relocation analysis server 102 determines, using the API 116, a second distance for each of the employees to the current office for each of the transportation modes based on the home addresses and the current office address. The relocation analysis server 102 generates a second carbon emission value for each of the transportation modes based on the stored emission value for each of the transportation modes and the second distances corresponding to each of the transportation modes. The relocation analysis server 102 then updates the dashboard GUI to include an emissions comparison of the current office and the one of the relocation offices. The emissions comparison is generated based on the second carbon emissions values and one of the first carbon emission values for the one of the relocation offices.

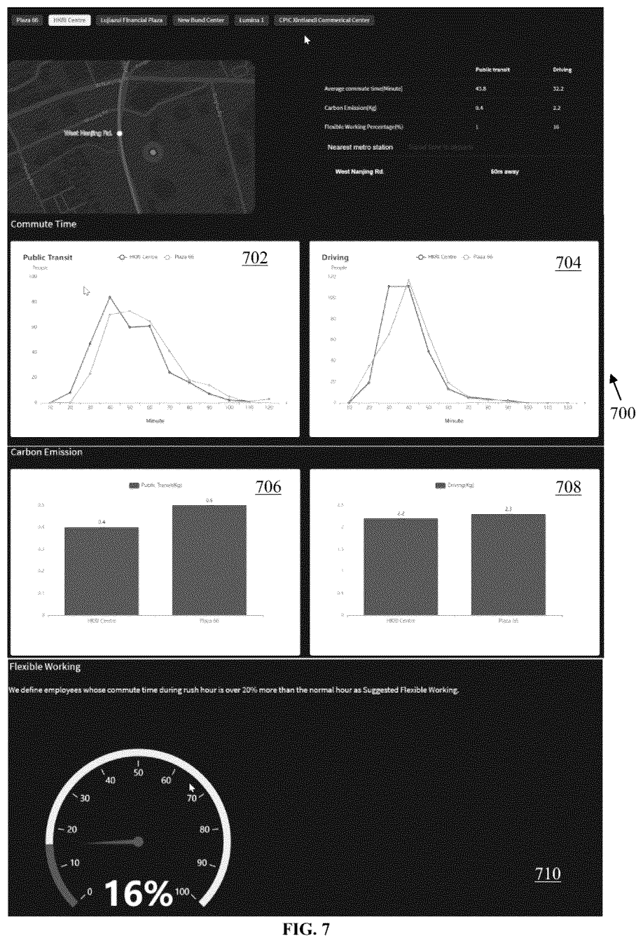

Referring to FIG. 7, a screenshot of another dashboard GUI 700 with comparison visualizations is illustrated. The dashboard GUI 700 includes a first commute time distribution 702 and a second commute time distribution 704. In this particular example, the relocation analysis system 102 determines, using the API 116, a transportation mode for each time period within each of the first commute times and the second commute times to generate the first and second commute time distributions 702 and 704 corresponding to particular transportation modes (i.e., public transit and driving, respectively), although the first and second commute time distributions 702 and 704 can correspond to overall commute times and other permutations can also be used in other examples.

The exemplary dashboard GUI 700 also includes a first emissions comparison 706 and a second emissions comparison 702 for the current office and the one of the relocation offices. The first and second emissions comparisons 702 and 704 similarly correspond to particular transportation modes (i.e., public transit and driving, respectively), although the first and second emissions comparisons 702 and 704 can correspond to overall commute times and other permutations can also be used in other examples.

In step 316, the relocation analysis system 102 determines, using the API 116, a third commute time for each of the employees to the one of the relocation offices corresponding to the selected one of the selectable locations based on the home addresses and the prospective office address for the one of the relocation offices. The third commute times each correspond with an off-peak or non-rush hour commute time period in this example whereas the second commute times correspond with a peak or rush hour commute time period.

In step 318, the relocation analysis system 102 determines that the third commute time for a subset of the employees exceeds by a stored, default threshold the second commute time for the subset of the employees for the one of the relocation offices. For example, the relocation analysis system 102 may determine that the third commute time for the one of the relocation offices exceeds the second commute time by more than the threshold 40% for 20% of the employees. In other words, 20% of the employees would experience a commute time to the one of the relocation offices that is 40% or more longer than their current commute time to the current office address. Other thresholds can also be used in other examples.

The relocation analysis system 102 then updates the dashboard GUI, or generates a new dashboard GUI, in step 318 to include another visualization generated based on a comparison of the subset of the employees to a total number of the employees. The comparison corresponds to a recommended flexible working percentage. In the example described above, the visualization would indicate that 20% of the employees would be recommended for a flexible working schedule outside of peak or rush hour commute time periods should the enterprise relocate to the one of the relocation offices.

Referring back to FIG. 7, the dashboard GUI 700 includes a visualization 710 that is in the form of a gauge or dial that indicates that 16% of employees would be recommended for a flexible working schedule should the one of the relocation offices be selected. Other visualizations can be included on any of the dashboard GUIs 500, 600, and 700 described and illustrated herein. Optionally, the relocation analysis system 102 can proceed back to step 310 based on user input received from one of the enterprise user devices 110(1)-110(n) in order to facilitate further visual comparisons between commute times and carbon emissions between current and/or relocation offices. Thus, steps 310-318 can be repeated for any number of selections of the selectable locations of relocation offices. Additionally, one or more of steps 300-318 can occur in a different order and/or in parallel in other examples.

As described and illustrated by way of the examples herein, this technology advantageously leverages data from external sources (e.g., commercial real estate databases and/or maps platforms) to facilitate relocation analytics and interactive graphical dashboards and interfaces that effectively efficiently present the analytics data. The relocation analysis systems of this technology more efficiently process enterprise and commercial real estate data to generate improved GUIs having visualizations, including heat maps, arranged in a particular, effective manner for interpreting relocation analytics data.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for visualizing relocation analytics, the method implemented by a relocation analysis system and comprising:
determining, using a maps platform application programming interface (API), a first commute time for each of a plurality of employees to a current office and a second commute time for each of the employees to each of a plurality of relocation offices, the first commute times determined based on home addresses for the employees and a current office address for the current office and the second commute times determined based on the home addresses and prospective office addresses for the relocation offices;
generating, and outputting to an enterprise user device for display, a dashboard graphical user interface (GUI) comprising a commute time ranking of the relocation offices and a heat map comprising selectable locations of the relocation offices and a graphical representation of an employee density determined based on the home addresses, the commute time ranking generated based on the second commute time for each of the relocation offices;
generating a first commute time distribution based on the first commute times and a second commute time distribution based on the second commute times for one of the relocation offices in response to a selection of one of the selectable locations corresponding to the one of the relocation offices received from the enterprise user device via the dashboard GUI; and
updating the dashboard GUI to include a visualization generated based on the first and second commute time distributions and outputting the updated dashboard GUI to the enterprise user device for display.

2. The method of claim 1, further comprising:
determining, using the maps platform API, a first distance for each of the employees to each of the relocation offices for each of a plurality of transportation modes, the first distances determined based on the home addresses and the prospective office addresses;
generating a first carbon emission value for each of the transportation modes for each of the relocation offices based on a stored emission value for each of the transportation modes and the first distances corresponding to each of the transportation modes; and
updating the dashboard GUI to include a carbon emission ranking of the relocation offices based on the first carbon emission values.

3. The method of claim 2, further comprising, in response to the selection of the one of the selectable locations:
determining, using the maps platform API, a second distance for each of the employees to the current office for each of the transportation modes, the second distances determined based on the home addresses and the current office address;
generating a second carbon emission value for each of the transportation modes based on the stored emission value for each of the transportation modes and the second distances corresponding to each of the transportation modes; and
updating the dashboard GUI to include an emissions comparison of the current office and the one of the relocation offices, the emissions comparison generated based on the second carbon emissions values and one of the first carbon emission values for the one of the relocation offices.

4. The method of claim 1, further comprising determining, using the maps platform API, one of a plurality of transportation modes for each of one or more time periods within each of the first commute times, the first commute time distribution corresponding to another one of the transportation modes.

5. The method of claim 1, wherein the second commute times correspond with a peak commute time period and the method further comprises, in response to the selection of the one of the selectable locations:
determining, using the maps platform API, a third commute time for each of the employees to the one of the relocation offices based on the home addresses and the prospective office address for the one of the relocation offices, wherein the third commute times each correspond with an off-peak commute time period;
determining that the third commute time for a subset of the employees exceeds by a threshold the second commute time for the subset of the employees for the one of the relocation offices; and
updating the dashboard GUI to include another visualization generated based on a comparison of the subset of the employees to a total number of the employees, wherein the comparison corresponds to a recommended flexible working percentage.

6. The method of claim 1, further comprising:
generating, using an office availability server API, a list of available offices satisfying one or more received parameters; and
receiving from the enterprise user device a selection via another GUI of the relocation offices from list of available offices.

7. A relocation analysis system, comprising memory having instructions stored thereon and one or more processors coupled to the memory and configured to execute the stored instructions to:
determine, using a maps platform application programming interface (API), a first commute time for each of a plurality of employees to a current office and a second commute time for each of the employees to each of a plurality of relocation offices, the first commute times determined based on home addresses for the employees and a current office address for the current office and the second commute times determined based on the home addresses and prospective office addresses for the relocation offices;
generate, and output to an enterprise user device for display, a dashboard graphical user interface (GUI) comprising a commute time ranking of the relocation offices and a heat map comprising selectable locations of the relocation offices and a graphical representation of an employee density determined based on the home addresses, the commute time ranking generated based on the second commute time for each of the relocation offices;
generate a first commute time distribution based on the first commute times and a second commute time distribution based on the second commute times for one of the relocation offices in response to a selection of one of the selectable locations corresponding to the one of the relocation offices received from the enterprise user device via the dashboard GUI; and
update the dashboard GUI to include a visualization generated based on the first and second commute time distributions and output the updated dashboard GUI to the enterprise user device for display.

8. The relocation analysis system of claim 7, wherein the processors are further configured to execute the stored instructions to
determine, using the maps platform API, a first distance for each of the employees to each of the relocation offices for each of a plurality of transportation modes, the first distances determined based on the home addresses and the prospective office addresses;
generate a first carbon emission value for each of the transportation modes for each of the relocation offices based on a stored emission value for each of the transportation modes and the first distances corresponding to each of the transportation modes; and
update the dashboard GUI to include a carbon emission ranking of the relocation offices based on the first carbon emission values.

9. The relocation analysis system of claim 8, wherein the processors are further configured to execute the stored instructions to, in response to the selection of the one of the selectable locations:
determine, using the maps platform API, a second distance for each of the employees to the current office for each of the transportation modes, the second distances determined based on the home addresses and the current office address;
generate a second carbon emission value for each of the transportation modes based on the stored emission value for each of the transportation modes and the second distances corresponding to each of the transportation modes; and
update the dashboard GUI to include an emissions comparison of the current office and the one of the relocation offices, the emissions comparison generated based on the second carbon emissions values and one of the first carbon emission values for the one of the relocation offices.

10. The relocation analysis system of claim 7, wherein the processors are further configured to execute the stored instructions to determine, using the maps platform API, one of a plurality of transportation modes for each of one or more time periods within each of the first commute times, the first commute time distribution corresponding to another one of the transportation modes.

11. The relocation analysis system of claim 7, wherein the second commute times correspond with a peak commute time period and the processors are further configured to execute the stored instructions to, in response to the selection of the one of the selectable locations:
determine, using the maps platform API, a third commute time for each of the employees to the one of the relocation offices based on the home addresses and the prospective office address for the one of the relocation offices, wherein the third commute times each correspond with an off-peak commute time period;
determine that the third commute time for a subset of the employees exceeds by a threshold the second commute time for the subset of the employees for the one of the relocation offices; and
update the dashboard GUI to include another visualization generated based on a comparison of the subset of the employees to a total number of the employees, wherein the comparison corresponds to a recommended flexible working percentage.

12. The relocation analysis system of claim 7, wherein the processors are further configured to execute the stored instructions to:
generate, using an office availability server API, a list of available offices satisfying one or more received parameters; and
receive from the enterprise user device a selection via another GUI of the relocation offices from list of available offices.

13. A non-transitory computer readable medium having stored thereon instructions for visualizing relocation analytics comprising executable code that, when executed by one or more processors, causes the processors to:
determine, using a maps platform application programming interface (API), a first commute time for each of a plurality of employees to a current office and a second commute time for each of the employees to each of a plurality of relocation offices, the first commute times determined based on home addresses for the employees and a current office address for the current office and the second commute times determined based on the home addresses and prospective office addresses for the relocation offices;
generate, and output to an enterprise user device for display, a dashboard graphical user interface (GUI) comprising a commute time ranking of the relocation offices and a heat map comprising selectable locations of the relocation offices and a graphical representation of an employee density determined based on the home addresses, the commute time ranking generated based on the second commute time for each of the relocation offices;
generate a first commute time distribution based on the first commute times and a second commute time distribution based on the second commute times for one of the relocation offices in response to a selection of one of the selectable locations corresponding to the one of the relocation offices received from the enterprise user device via the dashboard GUI; and
update the dashboard GUI to include a visualization generated based on the first and second commute time distributions and output the updated dashboard GUI to the enterprise user device for display.

14. The non-transitory computer readable medium of claim 13, wherein the executable code, when executed by the processors, further causes the processors to
determine, using the maps platform API, a first distance for each of the employees to each of the relocation offices for each of a plurality of transportation modes, the first distances determined based on the home addresses and the prospective office addresses;
generate a first carbon emission value for each of the transportation modes for each of the relocation offices based on a stored emission value for each of the transportation modes and the first distances corresponding to each of the transportation modes; and
update the dashboard GUI to include a carbon emission ranking of the relocation offices based on the first carbon emission values.

15. The non-transitory computer readable medium of claim 14, wherein the executable code, when executed by the processors, further causes the processors to, in response to the selection of the one of the selectable locations:
determine, using the maps platform API, a second distance for each of the employees to the current office for each of the transportation modes, the second distances determined based on the home addresses and the current office address;
generate a second carbon emission value for each of the transportation modes based on the stored emission value for each of the transportation modes and the second distances corresponding to each of the transportation modes; and
update the dashboard GUI to include an emissions comparison of the current office and the one of the relocation offices, the emissions comparison generated based on the second carbon emissions values and one of the first carbon emission values for the one of the relocation offices.

16. The non-transitory computer readable medium of claim 13, wherein the executable code, when executed by the processors, further causes the processors to determine, using the maps platform API, one of a plurality of transportation modes for each of one or more time periods within each of the first commute times, the first commute time distribution corresponding to another one of the transportation modes.

17. The non-transitory computer readable medium of claim 13, wherein the second commute times correspond with a peak commute time period and the executable code, when executed by the processors, further causes the processors to, in response to the selection of the one of the selectable locations:
determine, using the maps platform API, a third commute time for each of the employees to the one of the relocation offices based on the home addresses and the prospective office address for the one of the relocation offices, wherein the third commute times each correspond with an off-peak commute time period;
determine that the third commute time for a subset of the employees exceeds by a threshold the second commute time for the subset of the employees for the one of the relocation offices; and
update the dashboard GUI to include another visualization generated based on a comparison of the subset of the employees to a total number of the employees, wherein the comparison corresponds to a recommended flexible working percentage.

18. The non-transitory computer readable medium of claim 13, wherein the executable code, when executed by the processors, further causes the processors to
generate, using an office availability server API, a list of available offices satisfying one or more received parameters; and
receive from the enterprise user device a selection via another GUI of the relocation offices from list of available offices.
